(19) United States
(12) Patent Application Publication
(10) Pub. No.: US 2025/0272617 A1
(43) Pub. Date: Aug. 28, 2025

(54) EXTENSIBLE MACHINE LEARNING POWERED BEHAVIORAL FRAMEWORK FOR RISK COVERAGE

(71) Applicant: DIGITAL REASONING SYSTEMS, INC., FRANKLIN, TN (US)

(72) Inventors: Rebecca GRAHAM, Franklin, TN (US); Uday KAMATH, Franklin, TN (US); Kevin KENNAN, Franklin, TN (US); Sarah SORENSON, Franklin, TN (US); Garrett SOMMERS, Franklin, TN (US); Theo HILL, Franklin, TN (US)

(21) Appl. No.: 19/193,784

(22) Filed: Apr. 29, 2025

Related U.S. Application Data
(63) Continuation of application No. PCT/US2023/036484, filed on Oct. 31, 2023.
(60) Provisional application No. 63/381,635, filed on Oct. 31, 2022.

(51) Int. Cl. G06N 20/00

(52) U.S. Cl. CPC G06N 20/00

(57) ABSTRACT

Some aspects of the present disclosure relate to systems, methods and computer readable media for outputting alerts based on potential violations of predetermined standards of behavior. In one example implementation, a computer implemented method includes: training a natural language-based machine learning model to detect at least one risk of a violation condition in an electronic communication between persons, wherein the violation condition is a potential violation of a first predetermined standard of behavior; receiving a lexicon, wherein the lexicon comprises topic data; receiving connection data representing a relationship between the trained machine learning model and the lexicon; detecting, using the trained machine learning model, the lexicon, and the connection data, a potential violation of a second predetermined standard of behavior; and outputting for display an alert indicating the potential violation of the second predetermined standard of behavior.

### CROSS-REFERENCE TO RELATED APPLICATION

This application is a continuation of International Application No. PCT/US23/36484, filed on Oct. 31, 2023, and entitled “EXTENSIBLE MACHINE LEARNING POWERED BEHAVIORAL FRAMEWORK FOR RISK COVERAGE,” which claims priority to, and the benefit of, U.S. Provisional Patent Application No. 63/381,635, filed Oct. 31, 2022, and entitled “EXTENSIBLE MACHINE LEARNING POWERED BEHAVIORAL FRAMEWORK FOR RISK COVERAGE,” which are each hereby incorporated by reference in their entireties as if fully set forth below.

### BACKGROUND

The present disclosure generally relates to monitoring communications for activity that violates ethical, legal, or other standards of behavior and poses risk or harm to institutions or individuals. The need for detecting violations in the behavior of representatives of an institution has become increasingly important in the context of proactive compliance, for instance.

Conventionally, approaches have been taken for developing a distinct machine learning model to capture language of interest for each of several types of risks. This one-to-one relationship may entail a conventional use of building lexicons or models that map to regulatory policies. Detecting new types of risks can require training and maintaining additional models. For example, models that are trained to detect particular types of risk may not be able to detect different types of risk. Thus, as risk-detection systems and methods become more sophisticated, they require training and maintaining larger numbers of unique, risk-specific machine learning models.

It is with respect to these and other considerations that certain embodiments of the present disclosure are presented.

### SUMMARY

In the present application, according to some embodiments, a new framework is introduced for machine-learning analytics. In one exemplary implementation, the approach may be used for a highly extensible machine learning powered behavioral framework for, among other implementations, rapid risk coverage. Among other advantages and benefits provided by various embodiments, the present disclosure can successfully identify and take advantage of model reuse and composability opportunities as scenarios are implemented. Model reuse provides several possible advantages, including, but not limited to: accelerated expansion of a cognitive scenario catalog; improved analytic outcomes for most risk types; and reduced maintenance burden. As used herein, a “cognitive scenario catalog” refers to a collection of scenarios that can include trained machine learning models for analysis of electronic communications.

In one aspect, the present disclosure relates to a computer-implemented method, which, in one embodiment, includes training a natural language-based machine learning model to detect at least one risk of a violation condition in an electronic communication between persons, where the violation condition is a potential violation of a first predetermined standard of behavior; receiving a lexicon, where the lexicon includes topic data; receiving connection data representing a relationship between the trained machine learning model and the lexicon; detecting, using the trained machine learning model, the lexicon, and the connection data, a potential violation of a second predetermined standard of behavior; and outputting for display an alert indicating the potential violation of the second predetermined standard of behavior.

In some embodiments of the present disclosure, the lexicon includes a plurality of terms and phrases.

In some embodiments of the present disclosure, the trained natural language-based machine learning model is configured to output a machine learning alert based on the violation condition.

In some embodiments of the present disclosure, the lexicon is configured to detect a topic and output a topic alert.

In some embodiments of the present disclosure, the connection data includes logical relationships between the machine learning model and the lexicon.

In some embodiments of the present disclosure, the electronic communication is at least one of an SMS, MMS, email, chat, or audio communication.

In some embodiments of the present disclosure, the lexicon includes metadata.

In another aspect, the present disclosure relates to a computer-implemented method, which, in one embodiment, includes generating a plurality of trained machine learning models by training a plurality of machine learning models to detect features in an electronic communication; receiving a plurality of lexicons; receiving first connection data and second connection data; generating a first scenario including at least one of the plurality of machine learning models and at least one of the plurality of lexicons, and the first connection data, where the first connection data defines a relationship between the at least one of the plurality of machine learning models and the at least one of the plurality of lexicons; generating a second scenario, where the second scenario includes the first scenario, at least one of the plurality of lexicons, and the second connection data; detecting, using the second scenario, a potential violation of a predetermined standard of behavior; and outputting for display an alert indicating the potential violation of the predetermined standard of behavior.

In some embodiments of the present disclosure, the lexicon includes a plurality of terms and phrases.

In some embodiments of the present disclosure, the electronic communication is at least one of an SMS, MMS, email, chat, or audio communication.

In some embodiments of the present disclosure, the lexicon includes metadata.

In some embodiments of the present disclosure, the connection data includes logical relationships between outputs of the machine learning model and the lexicon.

In another aspect, the present disclosure relates to a system. In one embodiment, the system includes one or more processors; a memory connected to the one or more processors and storing computer-executable instructions which, when executed by the one or more processors, cause a computing device to perform steps that include: training a natural language based machine learning model to detect at least one risk of a violation condition in an electronic communication between persons, where the violation condition is a potential violation of a first predetermined standard of behavior; receiving a lexicon, where the lexicon includes topic data; receiving connection data representing a relationship between the trained machine learning model and the lexicon; detecting, using the trained machine learning model, the lexicon, and the connection data, a potential violation of a second predetermined standard of behavior; and outputting for display an alert indicating the potential violation of the second predetermined standard of behavior.

In some embodiments of the present disclosure, the lexicon includes a plurality of terms and phrases.

In some embodiments of the present disclosure, the trained machine learning model is configured to output a machine learning alert based on the violation condition.

In some embodiments of the present disclosure, the lexicon is configured to detect a topic and output a topic alert.

In some embodiments of the present disclosure, the connection data includes logical relationships between the trained machine learning model and the lexicon.

In some embodiments of the present disclosure, the electronic communication is at least one of an SMS, MMS, email, chat, or audio communication.

In some embodiments of the present disclosure, the lexicon includes metadata. In another aspect, the present disclosure relates to a system. In one embodiment, the system includes one or more processors; and a memory connected to the one or more processors and storing computer-executable instructions which, when executed by the one or more processors, cause a computing device to perform steps that include: generating a plurality of trained machine learning models by training a plurality of machine learning models to detect features in an electronic communication; receiving a plurality of lexicons; receiving first connection data and second connection data; generating a first scenario including at least one of the plurality of machine learning models and at least one of the plurality of lexicons, and the first connection data, where the first connection data defines a relationship between the at least one of the plurality of machine learning models and the at least one of the plurality of lexicons; generating a second scenario, where the second scenario includes the first scenario, at least one of the plurality of lexicons, and the second connection data; detecting, using the second scenario, a potential violation of a predetermined standard of behavior; and outputting for display an alert indicating the potential violation of the predetermined standard of behavior.

In some embodiments of the present disclosure, the lexicon includes a plurality of terms and phrases.

In some embodiments of the present disclosure, the electronic communication is at least one of an SMS, MMS, email, chat, or audio communication.

In some embodiments of the present disclosure, the lexicon includes metadata.

In some embodiments of the present disclosure, the connection data includes logical relationships between outputs of the machine learning model and the lexicon.

In another aspect, the present disclosure relates to a non-transitory computer-readable medium storing instructions which, when executed by one or more processors of a computing device, cause the computing device to perform steps that include: training a natural language based machine learning model to detect at least one risk of a violation condition in an electronic communication between persons, where the violation condition is a potential violation of a first predetermined standard of behavior; receiving a lexicon including lexical data, where the lexicon includes topic data; receiving connection data representing a relationship between the trained machine learning model and the lexicon; detecting, using the trained machine learning model, the lexicon, and the connection data, a potential violation of a second predetermined standard of behavior; and outputting for display an alert indicating the potential violation of the second predetermined standard of behavior.

In another aspect, the present disclosure relates to a non-transitory computer-readable medium, storing instructions which, when executed by one or more processors of a computing device, cause the computing device to perform steps that include: generating a plurality of trained machine learning models by training a plurality of machine learning models to detect features in text; receiving a plurality of lexicons; receiving first connection data and second connection data; generating a first scenario including at least one of the plurality of machine learning models and at least one of the plurality of lexicons, and the first connection data, where the first connection data defines a relationship between the at least one of the plurality of machine learning models and the at least one of the plurality of lexicons; generating a second scenario, where the second scenario includes the first scenario, at least one of the plurality of lexicons, and the second connection data; detecting, using the second scenario, a potential violation of a predetermined standard of behavior; and outputting for display an alert indicating the potential violation of the predetermined standard of behavior.

Other aspects and features according to example embodiments of the present disclosure will become apparent to those of ordinary skill in the art, upon reviewing the following detailed description in conjunction with the accompanying figures.

### BRIEF DESCRIPTION OF THE DRAWINGS

FIG. 1A illustrates a flowchart of a computer-implemented method for outputting an alert indicating a potential violation of a predetermined standard of behavior using lexicons, machine learning models, and connection data, according to embodiments of the present disclosure.

FIG. 1B illustrates a flowchart of a computer-implemented method for outputting an alert using a first and second scenario, where the second scenario includes the first scenario, a lexicon, and connection data defining the relationship between the first scenario and the lexicon, according to embodiments of the present disclosure.

FIG. 2A illustrates examples of risk signals and keywords in communications, according to embodiments of the present disclosure.

FIG. 2B illustrates examples of risk signals and keywords in communications.

FIG. 3 illustrates an example of scenario composition, according to embodiments of the present disclosure.

FIG. 4A illustrates an example of scenario composition to output conduct risk, according to embodiments of the present disclosure.

FIG. 4B illustrates an example of using the alerts output in FIG. 4A to compose additional scenarios, according to embodiments of the present disclosure.

FIG. 5 illustrates an example of signals and keywords that can be detected by lexicons and machine learning models, according to embodiments of the present disclosure.

FIG. 6 illustrates an example of signals and keywords that can be detected by lexicons and machine learning models, according to embodiments of the present disclosure.

FIG. 7 illustrates an example of signals and keywords that can be detected by lexicons and machine learning models, according to embodiment of the present disclosure.

FIG. 8 illustrates an example of a lexicon applied to a communication, according to embodiments of the present disclosure.

FIG. 9 illustrates an example computing device.

### DETAILED DESCRIPTION

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Certain values may be expressed in terms of ranges “from” one value “to” another value. When a range is expressed in terms of “from” a particular lower value “to” a particular higher value, or “from” a particular higher value “to” a particular lower value, the range includes the particular lower value and the particular higher value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more components in a device or system does not preclude the presence of additional components or intervening components between those components expressly identified.

### Definitions

The following discussion provides some descriptions and non-limiting definitions, and related contexts, for terminology and concepts used in relation to various aspects and embodiments of the present disclosure.

A “Scenario” can be a collection of one or more machine learning models and lexicons used to analyze communications and generate alerts based on the communications. The machine learning models can include conduct-specific machine learning models (i.e., machine learning models designed to detect communications that can correspond to certain types of conduct) and/or “topic mining” machine learning models. A topic mining machine learning model, as used herein, can be a machine learning model trained to identify “topics” within communications. An example of a topic mining machine learning model is a model trained to identify clusters of words or phrases in a communication. The Scenarios described herein can further include relationships between lexicons and/or machine learning models. The relationships between the lexicons and/or machine learning models can include various types of logical and mathematical relationships that can be used to determine whether a scenario generates an alert for a given communication based on whether the components of the scenario generate alerts. For example, the relationships can include Boolean logic elements (AND, OR, NOT, etc.) that cause alerts to only trigger if both, or, or neither of machine learning models or lexicons generate an alert. As another non-limiting example, the relationships can include mathematical relationships (e.g., numerical thresholds or certainty scores) used to determine whether the scenario generates a hit based on the outputs of the machine learning models and lexicons included in the scenarios.

A “Lexicon” can be a collection of terms (entries) that can be matched against text to find language of interest. It can be used as a component of a scenario that searches text for lexical patterns. The lexicon can include a series of terms/entries. Lexicons can further include metadata rules that are configured to detect the presence or absence of metadata associated with electronic communications. A compiled lexicon can be run on a corpus of text in order to generate hits. As described in greater detail herein, lexicons can be “composed” together as “scenarios” in various embodiments of the present disclosure.

An “alert” can represent a potential violation of a predetermined standard. It should be understood that, as used in the present disclosure, an “alert” or “alerts” can be displayed to the user, or can be not displayed to the user. In some embodiments, an “alert” or “alerts” are processed (i.e., “actioned”) by the systems and methods described herein without being displayed to a user and/or without any action being taken by a user. A signal that requires review can be considered an alert. As an example, an indication of intellectual property theft may be found in a chat post with language that matches the scenario, on a population that needs to be reviewed.

“Signals” are the portions of a communication that trigger the machine learning models, lexicons, or scenarios to output an “alert” based on the presence or absence of the signal (e.g., the portion of a communication that indicates there may be a violation of a predetermined policy). For example, a signal can include a keyword that matches a lexicon, or a pattern of text that a trained machine learning model is configured to detect. When a signal triggers a scenario, and the scenario is made up of one or more machine learning models, lexicons, and/or other scenarios, the signal can represent the portions of the communication that correspond to the machine learning models, lexicons, and/or other scenarios that comprise the scenario.

“Composition” can refer to generating and controlling relationships between scenarios, lexicons, and models. Scenarios described herein can be “composed” of any number of lexicons, other scenarios, or models. By composing lexicons, scenarios, and models together, embodiment of the present disclosure can automatically generate outputs (e.g., alerts) based on any number of related machine learning models, lexicons, and scenarios. As described throughout the present disclosure, the “composition” of scenarios, models, and lexicons performed by embodiments of the present disclosure allows for sophisticated alert generation, and further allows for the re-use and modification of scenarios, optionally without requiring re-training of machine learning models.

A “model” referred to herein is a machine learning model, including trained machine learning models and/or topic mining machine learning models. The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naive Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

“Operational risk” refers to risks detected by the targeted violation scenarios described herein.

“Scenario development” refers to using “composition” to combine models, scenarios, and lexicons to generate the scenarios described in the present disclosure.

A “communication” or “electronic communication” can be any event with language content, for example email, chat, a document, social media, or a phone call. An electronic communication may also include, for example, audio, SMS (“Short Message/Messaging Service”), MMS (“Multimedia Messaging Service”), and/or video. A communication may additionally or alternatively be referred to herein as, or with respect to, a “comm” (or “comms”), message, container, report, or data payload.

A “conversation” can be a group of semantically related posts, for example the entirety of an email with replies, a thread, or alternative a started and stopped topic, a time-bound topic, and/or a post with the other post (replies). Several posts can make up a conversation within a communication.

An “alert” can represent a potential violation of a predetermined standard. It should be understood that, as used in the present disclosure, an “alert” or “alerts” can be displayed to the user, or can be not displayed to the user. In some embodiments, an “alert” or “alerts” are processed (i.e., “actioned”) by the systems and methods described herein without being displayed to a user and/or without any action being taken by a user. Alternatively or additionally, the alert can be displayed to the user in some embodiments, and the alert can indicate to a user that a policy match (i.e., a potential violation of a predetermined standard) has occurred which requires action (sometimes referred to herein with respect to “actioning” an alert), for example a scenario match. A signal that requires review can be considered an alert. As an example, an indication of intellectual property theft may be found in a chat post with language that matches the scenario, on a population that needs to be reviewed.

A “pre-trained model” can be a model that performs a task but requires tuning (e.g., supervision and/or other interaction by an analyst or developer) before production. An “out of the box model” can be a model that benefits from, but does not require, tuning before use in production. Pre-trained models and out of the box models can be part of the building blocks for a policy.

In some embodiments, the present disclosure can provide for implementing analytics using “supervised” machine learning techniques (herein also referred to as “supervised learning”). Supervised mathematical models can encode a variety of different data aspects which can be used to reconstruct a model at run-time. The aspects utilized by these models may be determined by analysts and/or developers, for example, and may be fixed at model training time. Models can be retrained at any time, but retraining may be done more infrequently once models reach certain levels of accuracy.

### DESCRIPTION OF EXAMPLE EMBODIMENTS OF PRESENT DISCLOSURE

The following provides a non-limiting discussion of some example implementations of various aspects of the present disclosure. Some aspects and embodiments disclosed herein may be utilized for providing advantages and benefits in the area of communication surveillance for regulatory compliance. Some implementations can process all communications, including electronic forms of communications such as instant messaging (or “chat”), email, voice, and/or social network messaging to connect and monitor an organization's employee communications for regulatory compliance purposes.

Existing approaches to analyzing communications commonly use trained machine learning models to identify specific types of communications. For example, a machine learning model can be trained to identify communications including “secrecy,” “rumors,” “legal” content, or any other type of communications. Thus, each type of content can require an additional machine learning model to be trained. The requirement of a specific machine learning model for specific content limits existing systems, because training machine learning models can require significant time and resources. Training machine learning models also requires specialized skills. General purpose machine learning models (like large language models) require yet more resources to train, and can be difficult for users to fine tune to specific use cases.

Embodiments of the present disclosure include improvements to analyzing communications and outputting alerts based on the analysis of the communications. The systems and methods described herein include machine learning models and lexicons that are configured to analyze communications for specific signals and output alerts. As described above, the signals can correspond to portions of communications that indicate a potential violation of a predetermined policy. The scenarios described herein allow for multiple machine learning models and/or lexicons to be combined with each other, and for the same machine learning model or lexicon to be used with numerous other machine learning models or lexicons in different contexts. For example, a machine learning model, lexicon and/or scenario can be created that detects signals related to any potential violation of a predetermined standard (i.e., general misconduct), and that machine learning model and lexicon can then be combined with machine learning models and/or lexicons to generate “scenarios” that detect specific types of violations of specific predetermined standards. Thus, embodiments of the present disclosure allow reuse of machine learning models in different contexts using scenarios and lexicons, and therefore overcome the problems of conventional systems that require specific machine learning models to be trained for specific analysis tasks (e.g., detecting violations of predetermined standards in electronic communications).

As an example, embodiments of the present disclosure include systems and methods for combining machine learning models, scenarios, and/or lexicons. As described herein, machine learning models and lexicons can be configured to generate “alerts” based on the content of communications. In turn, embodiments of the present disclosure include scenarios that receive the alerts from the one or more machine learning models and lexicons, and then determine whether the scenario should output an alert based on the alerts received from the machine learning models and lexicons. The alerts output from the scenario can be used by any number of other scenarios to determine whether to output alerts from those scenarios. The relationship between scenarios, machine learning models, and lexicons can be defined by “connection data” that determines whether a scenario outputs an alert based on the outputs of the different components that make up the scenario (i.e., the scenarios, lexicons, and/or machine learning models that are composed together to make the scenario). Thus, any number of machine learning models, lexicons, and scenarios can be “composed” together to re-use machine learning models, lexicons, and scenarios across different tasks. Embodiments of the present disclosure include systems and methods for combining machine learning models and/or lexicons to detect multiple types of communications and output multiple types of alerts. By combining machine learning models and lexicons, embodiments of the present disclosure allow users to configure machine-learning based systems to detect and/or output various types of alerts without training additional models. For example, embodiments of the present disclosure include systems and methods that allow the same machine learning model to be re-used with multiple lexicons or other machine learning models. The combining of lexicons, scenarios and/or different types of machine learning models is referred to herein as “composition” or “composability.” The systems and methods described herein allow a user to “compose” a scenario that includes machine learning models and lexicons, and to specify the relationship between the machine learning models and lexicons. Embodiments of the present disclosure further include systems and methods to compose multiple scenarios together, so that scenarios can include other scenarios composed together with each other, and/or lexicons and machine learning models.

As a particular example, described in greater detail throughout the present disclosure, the present disclosure includes embodiments that generate alerts using combinations of “behavioral risk scenarios” and “targeted violation scenarios.” According to example embodiments of the present disclosure, communications (e.g., employee email, chat, and/or text) can be analyzed using systems that divide scenarios into two categories: behavioral risk scenarios and targeted violation scenarios. As used herein, behavioral risk scenarios detect human behaviors that signal conduct risk. A behavioral risk scenario may not indicate a violation of a specific policy, instead a behavioral risk scenario, according to various embodiments of the present disclosure, may represent behaviors that are present in more than one policy violation (as a non-limiting example, communications indicating a need for secrecy can indicate a potential violation of a policy without necessarily indicating which policy was violated. According to embodiments of the present disclosure, a behavioral risk scenario can include a machine learning model trained to detect potential behaviors in a communication, lexicon configured to detect the potential behavior, and/or another scenario configured to detect the potential behavior. Non-limiting examples of potential behaviors that can be detected by a behavioral risk scenario include rumors, secrecy, foreknowledge, concern/caution, boasting, concern, and/or any other behavior. It should be understood that machine learning models, lexicons, and scenarios can be trained to detect any type of potential behavior in a communication based on the systems and methods of the present disclosure. “Targeted violation scenarios” in the example embodiments represent controls that mitigate specific operational risks. A targeted violation scenario can represent a potential violation of a specific policy or standard. Non-limiting examples of targeted violation scenarios include market manipulation, bribes and kickbacks, and/or gifts and entertainment.

Thus, embodiments of the present disclosure can leverage the core behavioral risk signals detected by behavioral risk scenarios and can expand or refine those results based on additional, policy-specific, analytic components (e.g., components of the targeted violation scenarios). These violation-specific scenarios may map directly to specific regulatory controls such as market manipulation, bribes and kickbacks, and/or gifts and entertainment (G&E) violations, among others.

With regard to the speed of catalog expansion, model reusability can have the potential to accelerate development of new scenarios and make scenario development accessible beyond a data scientist team. As used herein, scenario development can refer to systems and methods for composing scenarios using other scenarios, trained machine learning models, and/or lexicons. Regarding analytic quality, according to some aspects of the present disclosure, improved analytic outcomes can use a reusable model approach for violation-specific risk areas. The ability to reuse machine learning models across multiple scenarios can reduce the maintenance burden. Conventionally, machine learning component(s) of a scenario can have great maintenance burden with regard to updates, improvements, reporting, augmentation effort, and/or government requirements, for instance.

In some aspects of the present disclosure, there is a different paradigm for detecting risk in electronic communications (e.g., employee communications). The example paradigm can divide scenarios into two categories: behavioral risk scenarios, and targeted violation scenarios. Behavioral risk scenarios detect human behaviors that signal conduct risk, do effectively to the heavy lifting of surfacing risk. These core behavioral models represent human psychological constructs such as secrecy, rumor, boasting, and concern. Constructs remain relatively constant even though regulations can change rapidly. According to some aspects, behavior-centric risk detection can provide coverage even when employees purposefully use veiled language. Targeted violation scenarios represent controls that mitigate specific operational risks. They can map directly to specific regulatory controls such as market manipulation, bribes, kickbacks, and gifts and entertainment (G&E) violations, among others. These can reuse behavioral models. The conduct risk signals detected by behavioral risk models can be used as a starting point, and then these results can be expanded or refined based on additional, violation-specific analytic components. The heavy lifting of risk detection can be performed by the behavioral models, so these scenarios can be easier to implement and maintain. These scenarios need only lightweight lexicons and metadata rules to refine or expand those risk signals to specific violation types. Use of a list of targeted violation scenarios can include converted versions of lexicons.

As discussed in some detail above, in some embodiments of the present disclosure, the best performing models may be behavior-focused rather than violation-focused. For example, whereas the models can perform well to find secrecy, rumor, change of venue, boasting, and others, these behaviors are not inherently violations. As a non-limiting example, it is not necessarily illegal to keep secrets, spread rumors, change communication channels, or boast. One reason a user of the systems described herein may want to see alerts on these behaviors is that, while not inherently violations they may nonetheless be suspicious; these behaviors represent known signals that users may map to specific violations.

Now describing some example behavior-focused models, according to some implementations of the present disclosure, there is a correspondence between an indication or indications of behavior the model is locating and a violation condition that a user is respectively concerned about. As an example, a model may find an indication of secrecy, which may correspond to all violation types (since, for instance, an employee may try to hide anything in an electronic communication. As another example, a model may find an indication of rumor dissemination which may correspond to sharing of privileged inside information or otherwise the sharing of non-public information. Further, quid-pro-quo type language as a detected behavior condition may correspond to bribery or collusion in market abuse. As another example, an indication in an electronic communication that users are changing venue of their communications (i.e., channel hopping) may correspond to all violation types. As yet another example, an indication of guarantees and assurances may correspond to customer treatment and/or market abuse. Further, an indication of boasting may correspond to customer treatment and/or fraud and/or market abuse.

In some aspects of the present disclosure, some models look directly for specific violation types. These violation-specific models can include: gifts and entertainment (G&E) policy violations, market manipulation, high pressure sales, investment recommendations, sexual harassment, and discrimination.

In the discussion above, each behavior item can be considered a violation; thus, models may be built to find the actual violations rather than looking for an associated signal. A comparison of behavior-focused models versus violation-focused models will now be described, in accordance with some aspects of the present disclosure. Whereas a behavior-focused model looks for a behavior, which can be considered a signal of a violation, a violation-focused model can look for a violation directly. A behavior-focused model may have many available positive examples for use in model training data, since the behaviors concerned may be relatively common; on the other hand, a violation-focused model may have few positive examples for training data, since the violations may be comparatively rare in relation to those for behavior-focused models. Moreover, whereas a behavior-focused model can classify behaviors, which are granular and likely to occur within a sentence span, they therefore can be a good fit for sentence-level classification. Comparatively, a violation-focused model can classify violations, which do not fall neatly into a sentence span (and therefore are not as strong of a fit for sentence-level classification).

Accordingly, in some implementations, behavior-focused models can be easier to create and can produce better outcomes as compared to violation-focused models. Users (e.g., compliance officers responsible for operating and/or maintaining automated electronic surveillance systems, such as those described in the present disclosure), nonetheless, can expect to be configuring automated electronic surveillance systems for specific violations such as G&E violations and market manipulation. In accordance with some implementations of the present disclosure, violation-specific use cases can be addressed using a behavior-focused approach.

Some aspects of the present disclosure relate to a paradigm which is sometimes referred to herein as a highly extensible machine learning powered behavioral framework for automatic computerized analysis of electronic communications. As mentioned in some detail above, in some implementations, this paradigm can divide scenarios into two categories: behavioral risk scenarios, in which human conduct risk can be detected; and targeted violation scenarios, in which controls are represented that mitigate specific operational risks. Each can leverage core behavioral risk signals and expand or refine those results based on additional, policy-specific analytic components. The violation-specific scenarios map directly to specific regulatory controls such as market manipulation, bribes and kickbacks, and/or G&E violations. In some implementations, behavioral machine-learning models can do the heavy lifting of surfacing risk; these core behavioral models can represent human psychological constructs such as secrecy, rumor, boasting, and concern. As mentioned above, while regulations may change, sometimes rapidly, these psychological constructs can remain relatively constant.

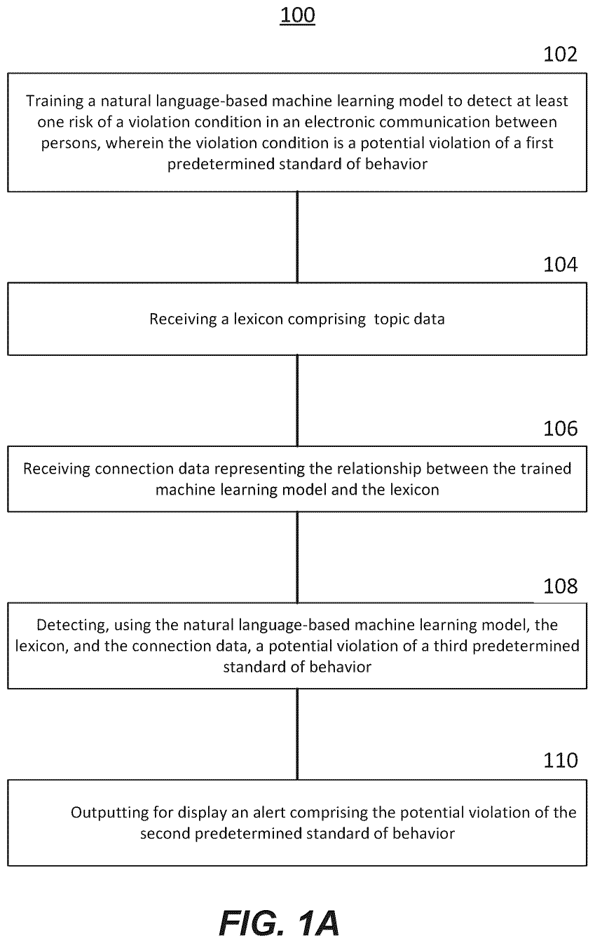

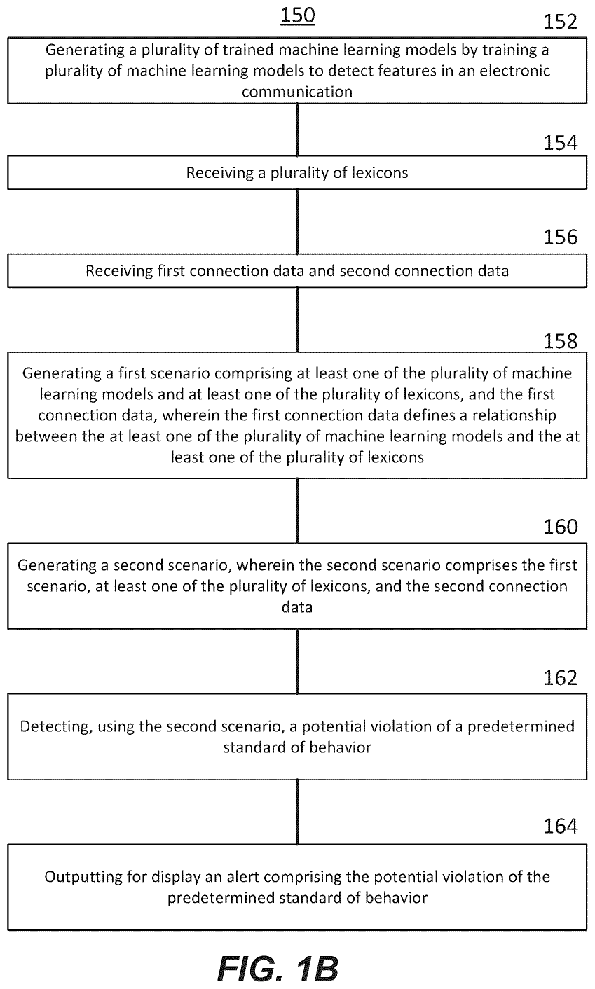

FIG. 1A illustrates an example computer-implemented method 100 of analyzing electronic communications using machine learning models, according to embodiments of the present disclosure. At step 102, the method can include training a natural language-based machine learning model to detect at least one risk of a violation condition in an electronic communication between persons. Non-limiting examples of electronic communications include SMS, MMS, email, chat and audio communications. The trained natural language-based machine learning model can optionally be configured to output a machine learning alert based on the violation condition.

As described throughout the present disclosure, the violation condition can be a potential violation of a first predetermined standard of behavior. Non-limiting examples of violations include the presence of communications indicating secrecy, rumor, change of venue, deception, boasting and/or conduct concerns. As used herein, “change of venue” refers to communications indicating that the communicator is “changing channels” from one type of communication to another type of communication.

At step 104, the method can further include receiving a lexicon including topic data. As used herein, “topic data” can refer to keywords, phrases, and/or metadata that can correspond to a “topic” in electronic communications. The lexicon can be configured so to detect the presence or absence of any combination of words, phrases and/or metadata within the electronic communications. The lexicon can include any number of terms or phrases. The “metadata” referred to with respect to the lexicon can refer to metadata rules that specify what types of metadata are included. Optionally, the lexicon can be configured to output a “topic alert” indicating the presence or absence of a topic within an electronic communication.

At step 106, the method can further include receiving connection data representing a relationship between the trained machine learning model and the lexicon. As used herein, “connection data” can include rules or relationships between one or more machine learning models and/or lexicons. In some embodiments of the present disclosure, the connection data can include logical relationships between the machine learning model and lexicon of the method 100 shown in FIG. 1A. The “connection data” described with reference to FIG. 1A and FIG. 1B enables the “composition” of machine learning models, scenarios, and/or lexicons as described throughout the present disclosure. In particular, the connection data defines and controls the relationships between the outputs of different machine learning models, lexicons, and/or scenarios, so that any combination of machine learning models, lexicons, and/or scenarios can be created, and so that the alert output for display to a user can be based on any combination of scenarios, machine learning models, and/or lexicons. At step 108, the method can further include detecting, using the trained machine learning mode, the lexicon, and the connection data, a potential violation of a second predetermined standard of behavior.

At step 110, the method can further include outputting for display an alert indicating the potential violation of the second predetermined standard of behavior.

FIG. 1B illustrates an example computer-implemented method 150 for configuring trained machine learning models to analyze electronic communications. Non-limiting examples of electronic communications include SMS, MMS, email, chat, and/or audio communications.

At step 152 the method can include generating a plurality of trained machine learning models by training a plurality of machine learning models to detect features in text.

At step 154 the method can include receiving a plurality of lexicons. Optionally, the plurality of lexicons can include any combinations of words, phrases, metadata, and/or metadata rules. Additionally, it should be understood that different lexicons in the plurality of lexicons can include different combinations of words, phrases, metadata and/or metadata rules.

At step 156 the method can include receiving first connection data and second connection data. As described with reference to the method 100 illustrated in FIG. 1A, the connection data can include logical relationships between the outputs of any number of machine learning models, lexicons, and/or scenarios.

At step 158 the method can include generating a first scenario comprising at least one of the plurality of machine learning models and at least one of the plurality of lexicons, and the first connection data, where the first connection data defines a relationship between the at least one of the plurality of machine learning models and the at least one of the plurality of lexicons.

At step 160 the method can includes generating a second scenario, where the second scenario includes the first scenario, at least one of the plurality of lexicons, and the second connection data.

At step 162 the method can include detecting, using the second scenario, a potential violation of a predetermined standard of behavior.

At step 164 the method can include outputting for display an alert indicating the potential violation of the predetermined standard of behavior.

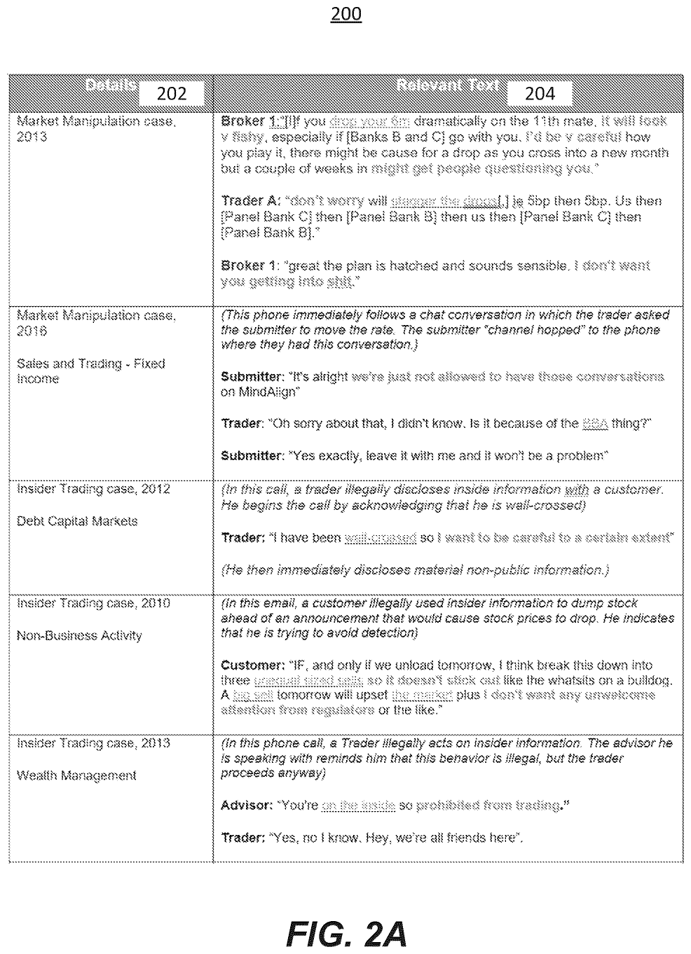

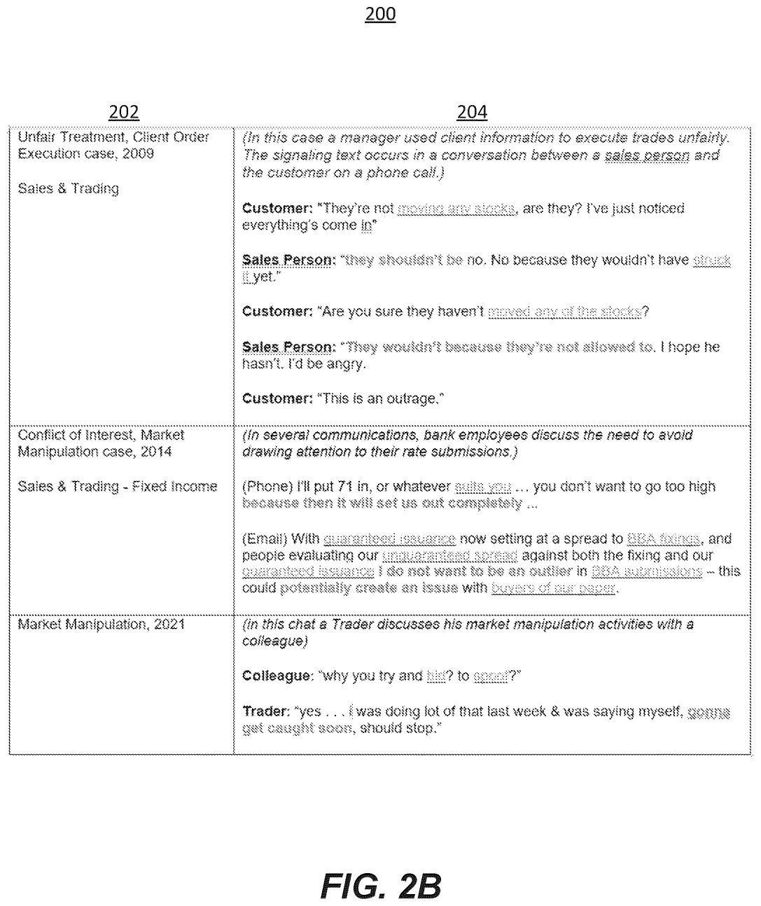

With reference to FIG. 2A-2B, a table 200 is shown including text corresponding to cases of misconduct. A details column 202 indicates the type of misconduct in the text. A “relevant text” column 204 shows text corresponding to the misconduct. Underlining in the text shows regulatory keywords which can be identified, for example, by the lexicons described herein. Bold in the text shows behavioral risk signals, which can be identified, for example, by the trained machine learning models described herein. FIG. 2B provides additional examples, continuing the table 200 illustrated in FIG. 2A.

FIGS. 2A-2B illustrate how behavioral risk signals (the bold text in FIGS. 2A-2B) cooccur with regulatory keywords (underlined text in FIGS. 2A-2B), creating a strong indicator of financial misconduct. It should be noted that the text in FIGS. 2A-2B is intended only as non-limiting examples. In many cases, public enforcement actions may typically include a small subset of an original communication. In many cases, the original communication may have significant additional context which was simply omitted from the public document used. Thus, analysis of public enforcement actions may give an incomplete view of how violations appear within communications.

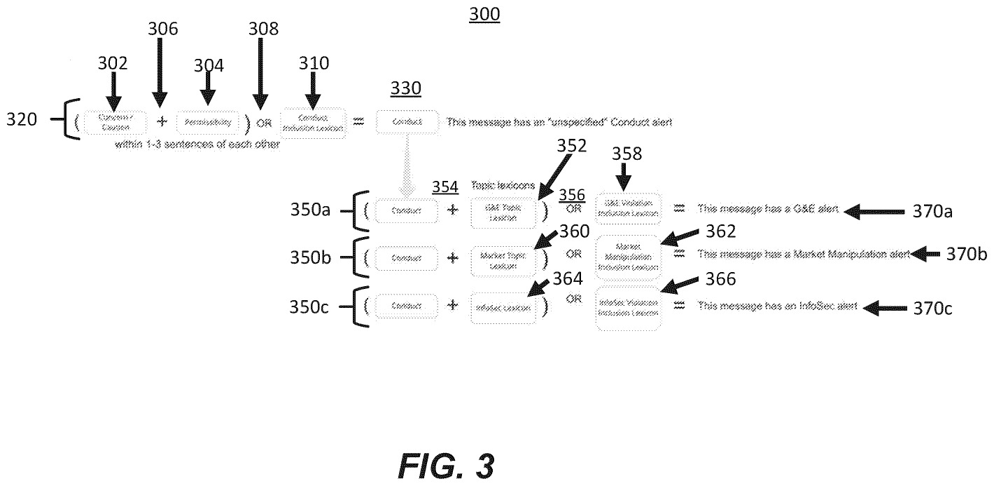

With reference to FIG. 3, a block diagram 300 of example implementation of the present disclosure is shown. The block diagram 300 illustrates how machine learning models, lexicons, and other scenarios can be composed together to output different types of alerts. As shown in FIG. 3, a concern/caution machine learning model 302 and a permissibility machine learning model 304 can be combined using a connector 306. As shown in FIG. 3, the connector can be an “AND” connector, where only a concern/caution alert and a permissibility alert within 1-3 sentences of each other can yield an output. It should be understood that the “1-3 sentences” connector shown in FIG. 3 is only a non-limiting example, and that any of the connectors described herein can be used.

Still with reference to FIG. 3, a second connector 308 is shown. The second connector 308 is an “or” connector that combines the result of the first connector 306 with the conduct inclusion lexicon 310. The concern/caution machine learning model 302 permissibility machine learning model 304, conduct inclusion lexicon 310, first connector 306 and second connector 308 can be referred to as a “scenario” 320. The scenario 320 can, in turn, output an alert 330. In the example shown in FIG. 3, the scenario 320 is configured to generate a “conduct alert” without being specific to a specific type of target violation or regulatory issue. In other words, the scenario 320 can combine the trained machine learning models that detect concern/caution and permissibility, as well as a conduct inclusion lexicon to output alerts 330 based on potential conduct violations. The alerts 330 can be used as a “general purpose” alert and combined with other scenarios, machine learning models, and/or lexicons to determine specific violations of predetermined standards.

Still with reference to FIG. 3, the alert 330 can be an input into additional scenarios 350a, 350b, 350c. A gifts and entertainment scenario 350a can include the conduct alert 330 combined with a gifts and entertainment lexicon 352 using a first connector 354. The gifts and entertainment scenario 350a can further include a gifts and entertainment violation inclusion lexicon 358 combined using a second connector 356. As used herein, an “inclusion lexicon” can be a targeted lexicon that serves as a “fallback” or “safety” to catch potential violations, so in the present example it is connected with an “OR” so that violations detected by the gifts and entertainment violation inclusion lexicon 358 or the conduct alert 330 and gifts and entertainment topic lexicon 352 result in the scenario 350a outputting a gifts and entertainment alert 370a.

Still with reference to FIG. 3, a market manipulation scenario 350b can include the conduct alert 330 combined with a market topic lexicon 360 using the first connector 354. The market manipulation scenario 350b can further include a market manipulation inclusion lexicon 362 and second connector 356.

Yet still with reference to FIG. 3, an information security (“infosec”) scenario 350c can include the conduct alert 330 combined with an information security lexicon 364 using the first connector 354. An information security violation inclusion lexicon 366 can also be included in the information security scenario 350c using the second connector.

Again with reference to FIG. 3, each of the scenarios 350a, 350b, 350c, can be configured to output alerts 370a, 370b, 370c corresponding to the scenarios. The gifts and entertainment scenario 350a can be configured to output a gifts and entertainment alert 370a based on the conduct alert 330, first connector 354, gifts and entertainment topic lexicon 352, second connector 356, and gifts and entertainment violation inclusion lexicon 358.

Similarly, the market manipulation scenario 350b can output a market manipulation alert 370b based on the conduct alert 330, market topic lexicon 360, market manipulation inclusion lexicon 362, first connector 354, and second connector 356.

Finally, the information security scenario 350c can output an information security alert 370c based on the conduct alert 330, information security lexicon 364, information security violation inclusion lexicon 366, first connector 354 and second connector 356. Thus, the example embodiment shown in FIG. 3 can use the same conduct alert 330 in multiple scenarios 350a, 350b, 350c to generate multiple alerts 370a 370b 370c for specific types of conduct.

It should be understood that, while the first connectors are all the same in FIG. 3, and the second connectors are all the same in FIG. 3, that different combinations of connectors could be used in different embodiments of the present disclosure. It should also be understood that, while three alerts 370a 370b 370c are shown in FIG. 3, any number of alerts can be inputs or outputs to the scenarios 350a 350b 350c. The present disclosure further contemplates that any number of scenarios can be joined together. For example, the alerts 370a 370b 370c shown in FIG. 3 can optionally be used as inputs to additional scenarios. Likewise, any number of alerts could be generated using the conduct alert 330. As yet another example, the scenario 320 that generates the conduct alert 330 can be configured to generate a different type of alert, using different models and lexicons. Furthermore, the scenario 320 can optionally include other scenarios as components. Thus, it is possible that any number of scenarios are “composed” together to generate the alerts that are ultimately displayed to a user of the system.

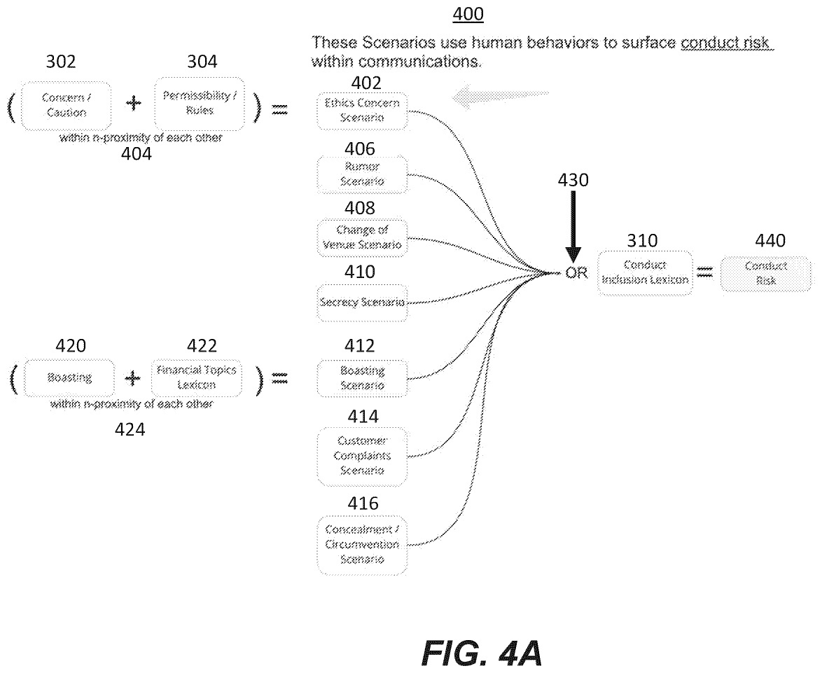

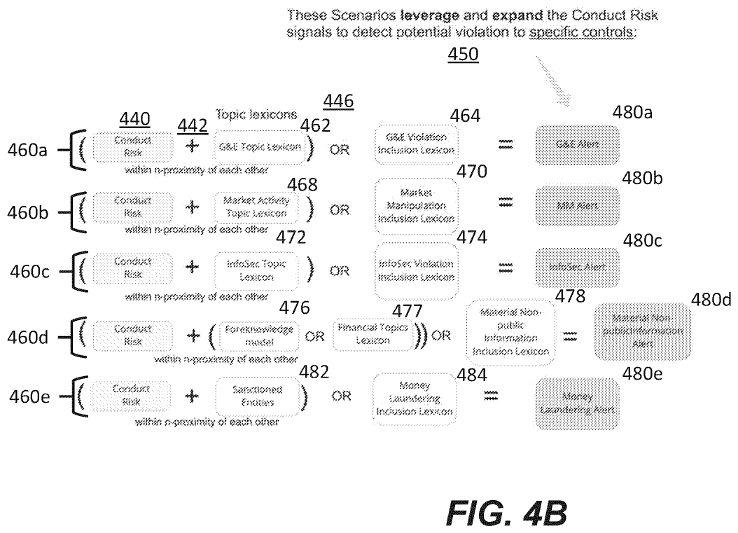

FIG. 4A illustrates a block diagram 400 of systems and methods for detecting conduct risk, according to an example embodiment of the present disclosure. An example ethics/concern scenario 402 includes a concern/caution machine learning model 302 and a permissibility machine learning model 304 combined using a “within n proximity” connector 404.

The block diagram 400 further includes a rumor scenario 406, a change of venue scenario 408, a secrecy scenario 410, a boasting scenario 412, a customer complaint scenario 414, and a concealment/circumvention scenario 416. The boasting scenario 412 can include a boasting machine learning model 420 that is designed to identify boasting in communications, combined with a financial topics lexicon 422 using an n-proximity connector 424. As shown in FIG. 4 A, each of the scenarios 402, 406, 408, 410, 412, 414, 416 can be composed together with an “or connector” 430 and a conduct inclusion lexicon 310. In other words, if any of the scenarios 402, 406, 408, 410, 412, 414, 416 generate an alert, or the conduct inclusion lexicon 310 generates an alert, a conduct risk alert 440 can be output.

Now with reference to FIG. 4B, a block diagram 450 illustrates how the conduct risk alert 440 can be composed together with lexicons to output alerts directed to specific behaviors in an example embodiment of the present disclosure. FIG. 4B illustrates five example scenarios 460a, 460b, 460c, 460d, 460e using the conduct risk alert 440. The conduct risk alert 440 can be composed together with lexicons using an n-proximity connector 442 and/or an “or” connector 446. Again, it should be understood that these connectors 442, 446 can be any connectors described herein.

A gifts and entertainment scenario 460a can include the conduct risk alert 440 composed with a gifts and entertainment topic lexicon 462 and a gifts and entertainment violation inclusion lexicon 464, as shown in FIG. 4B. The gifts and entertainment scenario 460a can output a gifts and entertainment alert 480a. A market manipulation scenario 460b can include the conduct risk alert 440 composed together with a market activity topic lexicon 468 and a market manipulation inclusion lexicon 470. The market manipulation scenario 460b can be configured to output a market manipulation alert 480b.

An information security scenario 460c can include the conduct risk alert 440 composed together with an information security topic lexicon 472 and an information security violation inclusion lexicon 474. The information security scenario 460c can be configured to output an information security alert 480c.

Again, as described with reference to FIG. 3, embodiments of the present disclosure can combine any number of machine learning models, lexicons, and/or scenarios. As shown in FIG. 4B, a scenario 460d can include the conduct risk alert 440 composed together with a foreknowledge model 476, a financial topics lexicon 477, and a material non-public information inclusion lexicon 478. The scenario 460d can be configured to output a material non-public information alert 480d.

Finally, still with reference to FIG. 4B, a money laundering scenario 460e can include a conduct risk alert 440 composed together with a sanctioned entities lexicon 482, and a money laundering inclusion lexicon 484. The money laundering scenario 460e can be configured to output a money laundering alert 480e.

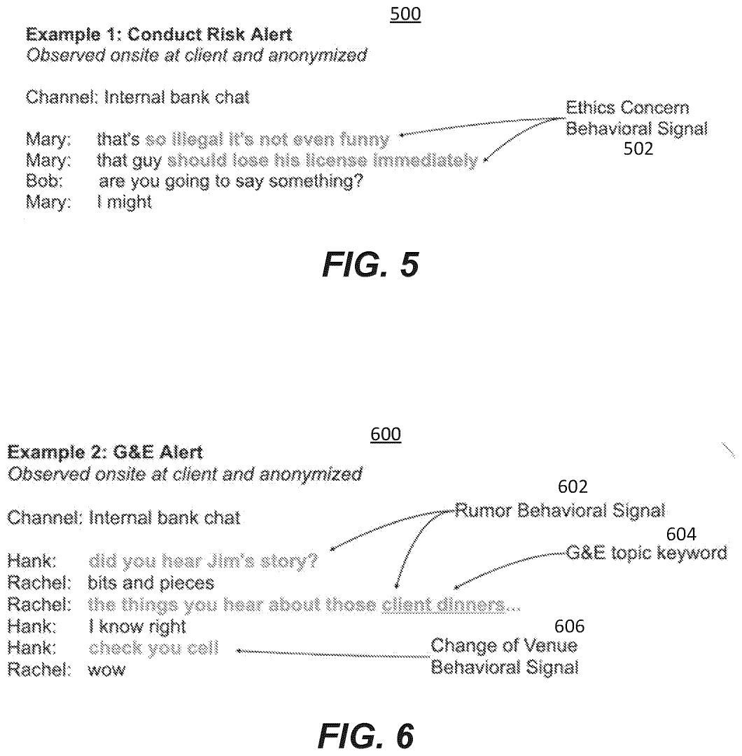

FIG. 5 (“Example 1”) illustrates an example conduct risk alert 500 including an ethics concern behavioral signal 502. The ethics concern behavioral signal is a non-limiting example of a communication that can be detected by an ethics concern scenario (e.g., the ethics concern scenario 402 described with reference to FIG. 4A). FIG. 5 illustrates that behavioral risk scenarios can be useful independent of any violation-specific signals. FIG. 5 shows an example of a conduct risk alert observed onsite. The names “Mary” and “Bob” are fictitious and are not intended to refer to any specific real-life individual(s). The electronic communication dialogue shown has its channel in an internal bank chat resource. Notably, while this example contains an example behavioral risk signal (the ethics concern behavioral signal 502), it does not contain violation-specific indicators. Therefore, it can optionally be labeled a conduct risk alert. In the example shown in FIG. 5, the employees are using vague language, so it may not be clear which type of violation they are discussing. However, the behavioral risk signals can make it clear that some sort of violation has potentially occurred and is being discussed. Thus, the systems described herein can optionally store or output the conduct risk alert 500 and/or ethics concern behavioral signal 502 to alert users (e.g., compliance officers) of potential violations. FIG. 6 (“Example 2”) illustrates an example gifts and entertainment alert 600 including a rumor behavioral signal 602, a gifts and entertainment topic keyword 604, and a change of venue behavioral signal 606. The rumor behavioral signal can optionally be detected using any or all of the components of a rumor scenario (e.g., the rumor scenario 406 shown in FIG. 4A). The entertainment topic keyword can optionally be detected using a gifts and entertainment topic lexicon (e.g. the gifts and entertainment topic lexicon 462 shown in FIG. 4B). The change of venue behavioral signal can optionally be detected using a change of venue scenario (e.g., the change of venue scenario 408 shown in FIG. 4A).

FIG. 6 includes an example electronic communication can include multiple behavioral risk signals (e.g., the rumor behavioral signal 602, and change of venue behavioral signal 606). It also contains a topic keyword associated with gifts and entertainment (G&E) (the gifts and entertainment topic keyword 604). Therefore, a violation-specific gifts and entertainment alert 600 is generated. As with FIG. 5, “Hank” and “Rachel” are fictitious for illustrative purposes and are not intended to refer to any specific real-life individual(s). Optionally, the presence of the term “client dinner” would not generate an alert in absence of behavioral risk signals; in the example embodiment, if the words “client dinner” were removed from this conversation, the behavioral risk signals would still be present and a conduct risk alert would be generated. In other words, in the example embodiment shown in FIG. 6, the behavioral signals allow for detecting risk and the keywords allow for further refining the risk into a specific violation type. Thus, the example embodiment can automatically detect risk and classify the risk using combinations of machine learning models and lexicons, according to embodiments of the present disclosure. In this electronic conversation between “Hank” and “Rachel”, the employees are engaging in rumor behavior and making veiled references to potential G&E violations. Also, their change of venue behavior indicates that the employees may be intentionally avoiding communications monitoring. Users (e.g., compliance officers) would likely, therefore, want to take action to determine if a G&E violation did occur. Additionally, regardless of whether a G&E violation(s) occurred, the employees identified as potentially violating a predetermined G&E policy can be assigned additional training (e.g., by a computerized training system) or have their access to computer systems curtailed or denied until a manual review is completed.

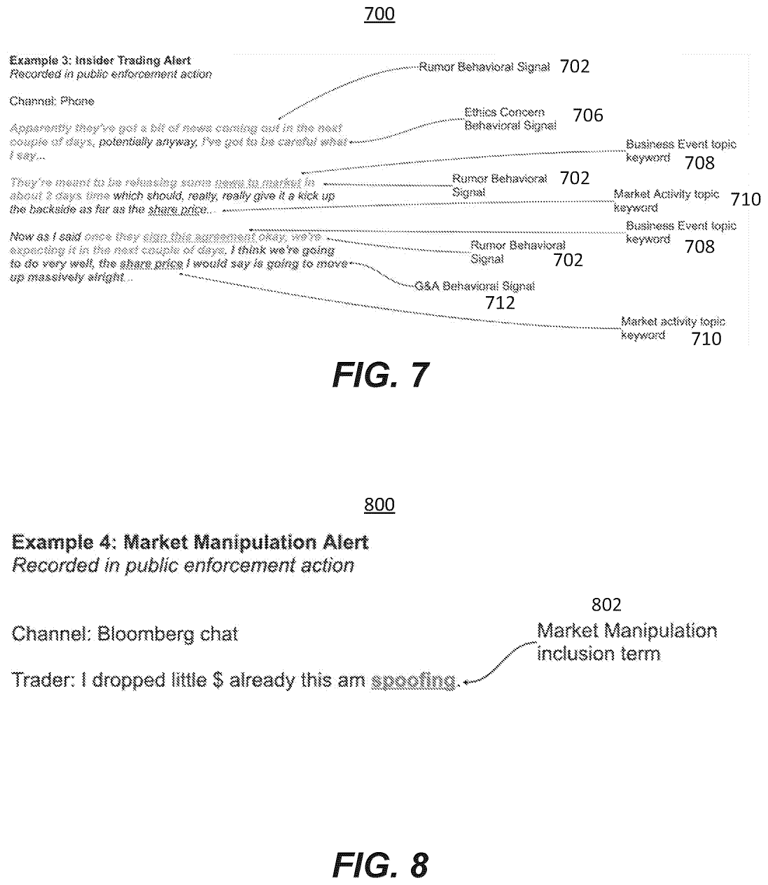

It should be understood that communications can include any number of keywords or signals that can trigger alerts in corresponding lexicons and models. FIG. 7 (“Example 3”) illustrates an example insider trading alert 700. The insider trading alert includes rumor behavioral signals 702. Again, the rumor behavioral signal 702 can optionally be detected using any or all of the components of a rumor scenario (e.g., the rumor scenario 406 shown in FIG. 4A). The insider trading alert 700 can further include an ethics concern behavioral signal 706 that can be detected by an ethics concern scenario (e.g., the ethics concern scenario 402 described with reference to FIG. 4). The insider trading alert 700 can further include a business event topic keyword alert 708 (e.g., detected by a business event topic keyword lexicon). The insider trading alert 700 can further include market activity topic keyword alerts 710 (e.g., detected by the market activity topic lexicon 468 shown in FIG. 4B). As yet another example, the insider trading alert 700 can further include a G&A (“general and administrative”) behavioral signal 712 that can optionally be detected by a G&A model.

FIG. 7 illustrates an example communication including an insider trading alert 700. FIG. 0.7 is an example transcription of a phone conversation including multiple behavioral risk signals (e.g., the rumor behavioral signal 702, the ethics concern behavioral signal 706, and the G&A behavioral signal 712). It also contains topic keywords that indicate market activity and business events. In some implementations of the present disclosure, this combination of signals allows for further refinement of the conduct risk to a specific violation type, namely insider trading in the non-limiting example shown in FIG. 7.

As still yet another example, FIG. 8 (“Example 4”) illustrates an example market manipulation alert 800. The market manipulation alert 800 can include a market manipulation inclusion term 802. Optionally, the market manipulation inclusion term 802 can be detected using a market manipulation inclusion lexicon (e.g., the market manipulation inclusion lexicon 362 shown in FIG. 3). Alternatively or additionally, the market manipulation inclusion term 802 can be detected using a market manipulation scenario 350b, as shown in FIG. 3.

FIG. 8 illustrates an electronic communication via Bloomberg chat which illustrates, in accordance with certain implementations of the present disclosure, violation-specific inclusion lexicons (e.g., a market manipulation inclusion lexicon configured to detect a market manipulation inclusion term 802) that expand the risk coverage of behavioral models. Although the text from the “Trader” shown in the example does not contain behavioral risk signals, it contains an explicit reference to a violation, namely “spoofing.” It therefore can be captured by a violation-specific, market manipulation inclusion lexicon, and a market manipulation alert can be generated accordingly. Inclusion lexicons (e.g., any of the lexicons described herein) can be utilized by users of electronic surveillance systems to ensure that the systems will output alerts when certain terms are used in the electronic communications, regardless of the surrounding context and the presence or absence of behavioral signals. In some implementations, violation-specific scenarios map directly to specific regulatory signals such as market manipulation, bribes and kickbacks, and G&E violations, for example. In these implementations, behavioral models can be reused; conduct risk signals detected by the behavioral risk models can be used as a starting point and then the results can be expanded or refined based on additional, violation-specific, analytic components. According to some implementations, these scenarios can be much easier to implement and maintain because the heavy lifting of risk detection is already performed by the behavioral models; such scenarios may only require lightweight lexicons and metadata rules to refine or expand those risk signals to specific violation types.

It should be understood that the “signals” identified in FIGS. 5-8 can represent the portions of a communication that trigger a machine learning model or lexicon to output an “alert” based on the presence or absence of a signal. For example, the “ethics concern behavioral signal” 502 shown in FIG. 5 can be the portion of the communication that causes the ethics concern scenario 402 shown in FIG. 4A to output an alert. Again, as described herein, the ethics concern scenario can include machine learning models and/or lexicons configured to detect ethics concern signals in communications.

It should be understood that the systems and methods described with reference to FIGS. 1 A-8 can be combined in different orders and/or combinations as part of automatic systems for analyzing electronic communications and generating alerts. As a non-limiting example, an embodiment of the present disclosure includes a computer-implemented method. The computer implemented method uses a false positive reduction filter to filter the electronic communications. An example of a false positive reduction filter is a filter that removes repetitive and automatic communications that are irrelevant to determining whether violations occur in the electronic communications. Examples of communications that can be filtered at this step include disclaimers, newsletters, news articles, and automatic emails.

The filtered communications can be analyzed using machine learning models configured to detect communications with potential misconduct, based on detected behavior signals. Any number or combination of trained machine learning models can be used to identify electronic communications with signals indicating rumor, secrecy, change of venue, deception, boasting, or conduct concerns. The machine learning models can be configured to identify sections of the communications corresponding to these signals, and any other behavior signal. Again, as described above, the present disclosure contemplates that trained machine learning models can be configured to detect any type of potential misconduct or behavior in electronic communications and/or identify sections of the electronic communications that include the potential misconduct or behavior.

The electronic communications or sections of electronic communications identified by the trained machine learning models can optionally be categorized using any number of lexicons. The lexicons can be “topic lexicons” that include metadata and/or words associated with particular topics. The topic lexicons can be used to categorize the electronic communications identified by the trained machine learning models into different categories of alerts.

It should further be understood that targeted “inclusion lexicons” can optionally be used in addition to the machine learning models as a “check” on the trained machine learning models. For example, the system can be configured so that when an electronic communication or section of an electronic communication is identified as a potential violation by an inclusion lexicon, an alert is output regardless of whether the communication is identified as a potential violation by the machine learning model.

### Example Computing System Architecture

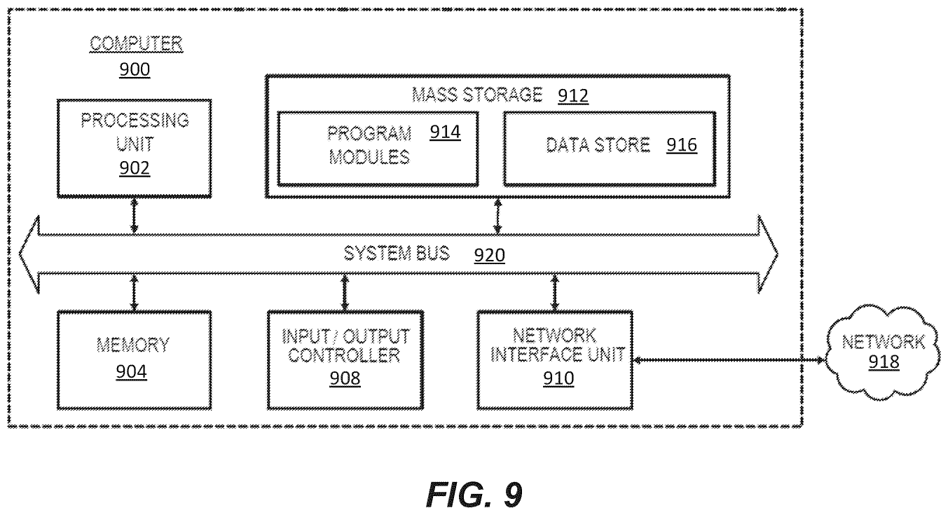

FIG. 9 is a computer architecture diagram showing a general computing system capable of implementing one or more embodiments of the present disclosure described herein. A computer 900 may be configured to perform one or more functions associated with embodiments illustrated in, and described with respect to, one or more of FIGS. 1 A-8. It should be appreciated that the computer 900 may be implemented within a single computing device or a computing system formed with multiple connected computing devices. For example, the computer 900 may be configured for a server computer, desktop computer, laptop computer, or mobile computing device such as a smartphone or tablet computer, or the computer 900 may be configured to perform various distributed computing tasks, which may distribute processing and/or storage resources among the multiple devices.

As shown, the computer 900 includes a processing unit 902, a system memory 904, and a system bus 920 that couples the memory 904 to the processing unit 902. The computer 900 further includes a mass storage device 912 for storing program modules 914. The program modules 914 may include modules executable to perform one or more functions associated with embodiments illustrated in, and described with respect to, one or more of FIGS. 1A-8. The mass storage device 912 further includes a data store 916.

The mass storage device 912 is connected to the processing unit 902 through a mass storage controller (not shown) connected to the bus. The mass storage device 912 and its associated computer storage media provide non-volatile storage for the computer 900. By way of example, and not limitation, computer-readable storage media (also referred to herein as “computer-readable storage medium” or “computer-storage media” or “computer-storage medium”) may include volatile and non-volatile, removable and non-removable media implemented in any method or technology for storage of information such as computer-storage instructions, data structures, program modules 914, or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900. Computer-readable storage media as described herein does not include transitory signals.

According to various embodiments, the computer may operate in a networked environment using connections to other local or remote computers through a network 918 via a network interface unit 910 connected to the bus. The network interface unit 910 may facilitate connection of the computing device inputs and outputs to one or more suitable networks and/or connections such as a local area network (LAN), a wide area network (WAN), the Internet, a cellular network, a radio frequency network, a Bluetooth-enabled network, a Wi-Fi enabled network, a satellite-based network, or other wired and/or wireless networks for communication with external devices and/or systems.

The computer 900 may also include an input/output controller 908 for receiving and processing input from a number of input devices. Input devices may include, but are not limited to, keyboards, mice, stylus, touchscreens, microphones, audio capturing devices, or image/video capturing devices. An end user may utilize such input devices to interact with a user interface, for example a graphical user interface on one or more display devices (e.g., computer screens), for managing various functions performed by the computer 900, and the input/output controller 908 may be configured to manage output to one or more display devices for visually representing data.

The bus may enable the processing unit 902 to read code and/or data to/from the mass storage device 912 or other computer-storage media. The computer-storage media may represent apparatus in the form of storage elements that are implemented using any suitable technology, including but not limited to semiconductors, magnetic materials, optics, or the like. The program modules 914 may include software instructions that, when loaded into the processing unit 902 and executed, cause the computer 900 to provide functions associated with embodiments illustrated in, and described with respect to, one or more of FIGS. 1A-8. The program modules 914 may also provide various tools or techniques by which the computer 900 may participate within the overall systems or operating environments using the components, flows, and data structures discussed throughout this description. In general, the program module may, when loaded into the processing unit 902 and executed, transform the processing unit 902 and the overall computer 900 from a general-purpose computing system into a special-purpose computing system.

### CONCLUSION

The various example embodiments described above are provided by way of illustration only and should not be construed to limit the scope of the present disclosure. Those skilled in the art will readily recognize various modifications and changes that may be made to the present disclosure without following the example embodiments and applications illustrated and described herein, and without departing from the true spirit and scope of the present disclosure.

What is claimed is:

1. A computer-implemented method, comprising:
training a natural language-based machine learning model to detect at least one risk of a violation condition in an electronic communication between persons, wherein the violation condition is a potential violation of a first predetermined standard of behavior;
receiving a lexicon, wherein the lexicon comprises topic data;
receiving connection data representing a relationship between the trained machine learning model and the lexicon;
detecting, using the trained machine learning model, the lexicon, and the connection data, a potential violation of a second predetermined standard of behavior; and
outputting for display an alert indicating the potential violation of the second predetermined standard of behavior.

2. The computer-implemented method of claim 1, wherein the lexicon comprises a plurality of terms and phrases.

3. The computer-implemented method of claim 1, wherein the trained natural language-based machine learning model is configured to output a machine learning alert based on the violation condition.

4. The computer-implemented method of claim 1, wherein the lexicon is configured to detect a topic and output a topic alert.

5. The computer-implemented method of claim 1, wherein the connection data comprises logical relationships between the machine learning model and the lexicon.

6. The computer-implemented method of claim 1, wherein the electronic communication is at least one of: an SMS, MMS, email, chat, or audio communication.

7. The computer-implemented method of claim 1, wherein the lexicon comprises metadata.

8. A computer-implemented method, comprising:
generating a plurality of trained machine learning models by training a plurality of machine learning models to detect features in an electronic communications;
receiving a plurality of lexicons;
receiving first connection data and second connection data;
generating a first scenario comprising at least one of the plurality of machine learning models and at least one of the plurality of lexicons, and the first connection data, wherein the first connection data defines a relationship between the at least one of the plurality of machine learning models and the at least one of the plurality of lexicons;
generating a second scenario, wherein the second scenario comprises the first scenario, at least one of the plurality of lexicons, and the second connection data;
detecting, using the second scenario, a potential violation of a predetermined standard of behavior; and
outputting for display an alert indicating the potential violation of the predetermined standard of behavior.

9. The computer-implemented method of claim 8, wherein the lexicon comprises a plurality of terms and phrases.

10. The computer-implemented method of claim 8, wherein the electronic communication is at least one of: an SMS, MMS, email, chat, or audio communication.

11. The computer-implemented method of claim 8, wherein the lexicon comprises metadata.

12. The computer-implemented method of claim 8, wherein the connection data comprises logical relationships between outputs of the machine learning model and the lexicon.

13. A system, comprising:
one or more processors; and
a memory connected to the one or more processors, the one or more processors being configured to:
train a natural language-based machine learning model to detect at least one risk of a violation condition in an electronic communication between persons, wherein the violation condition is a potential violation of a first predetermined standard of behavior;
receive a lexicon, wherein the lexicon comprises topic data;
receive connection data representing a relationship between the trained machine learning model and the lexicon;
detect, using the trained machine learning model, the lexicon, and the connection data, a potential violation of a second predetermined standard of behavior; and
output for display an alert indicating the potential violation of the second predetermined standard of behavior.

14. The system of claim 13, wherein the lexicon comprises a plurality of terms and phrases.

15. The system of claim 13, wherein the trained machine learning model is configured to output a machine learning alert based on the violation condition.

16. The system of claim 13, wherein the lexicon is configured to detect a topic and output a topic alert.

17. The system of claim 13, wherein the connection data comprises logical relationships between the trained machine learning model and the lexicon.

18. The system of claim 13, wherein the electronic communication is at least one of: an SMS, MMS, email, chat, or audio communication.

19. The system of claim 13, wherein the lexicon comprises metadata.

20. The system of claim 13, wherein the one or more processors is further configured to generate a plurality of trained machine learning models by training a plurality of machine learning models to detect features in electronic communications, wherein the plurality of trained machine learning models comprises the natural language-based machine learning model.
